(19) United States
(12) Patent Application Publication
(10) Pub. No.: US 2006/0212934 A1
(43) Pub. Date: Sep. 21, 2006

(54) Identity and access management system and method

(76) Inventors: Allan Cameron, Saint John (CA); Richard Hartley Matthews, Quispamsis (CA); Richard J. MacPhee, Saint John (CA)

Correspondence Address: SALTAMAR INNOVATIONS, 30 FERN LANE, SOUTH PORTLAND, ME, 04106, US

(21) Appl. No.: 11/082,338

(22) Filed: Mar. 17, 2005

(51) Int. Cl. H04L 9/32; G06F 15/16; G06K 9/00; G06F 17/00; G06F 17/30; G06F 9/00; G06F 7/04; G06F 7/58; G06K 19/00

(52) U.S. Cl. 726/12; 726/4

(57) ABSTRACT

A method and system for providing access control to networked resources is provided. Optimally, the system comprises at least one networked resource coupled to the internet via a gateway having a ‘private’ or ‘internal’ side coupled to an intranet, and a ‘public’ or ‘external’ side coupled to the internet, and the gateway controls access to the resource. An access controller is coupled to the external side of the gateway, i.e. outside the intranet. Upon access request by an access requester, the gateway communicates the request to the access controller. The access controller utilizes the requested URL to select a login applet that is communicated to the requester. When the requester returns the login information, the access controller authenticates the user and generates an access management applet specific to the user. The access management applet controls access to the networked resources in conjunction with code on the gateway. Additional optional features include auditing and the capacity to provide access to several organizations using a single login.

### FIELD OF THE INVENTION

The invention relates generally to computer systems security, and more specifically to a system and method for managing user identity, and other user privileges in computerized systems.

### BACKGROUND

Computer systems security presents a major problem that consumes vast amount of resources. A prominent problem in the field is managing and verifying user identities, and once verified, managing what is commonly known as the user ‘profile’, i.e. a collection of access rights to access and/or modify certain data, preferences, and the like. Such access rights may be provided for many levels, such as a system, a computer within the system, a directory, a file, or even individual records in a database, or parts thereof. Most ominous is the connection between the internal communications facilities of an organization, commonly known as an “Intranet” and an external communication facility, such as the Internet. (It should however be noted that the term Internet as used in these specifications relates to any wide area communication network or even a local area communication network, that is not wholly under the control of the organization).

FIG. 1 represents a common example of a secure remote access solutions, as presently known. Such systems are configured as stand alone systems, usually on the organization premises. They are connected to the Internet 10 via a blocking gateway arrangement such as an IP switch, a router, a firewall, and the like 20. Such a separating devices, acting to separate between the Internet and the Intranet, (conceptually along the dashed line 12 separating the organization resources from the Internet) is referred to hereinafter as an IP Gateway or IPG. The IPG has an ‘external’ side connected to the Internet (or equivalently to any publicly accessible network), and an ‘internal’ side, coupled to the intranet, and/or the networked resources that are under the organization control. Access between the Internet 10 and the Intranet 30, and therefore access to the resources 40 available on the Intranet, is controlled by the IPG 20, in accordance with an internal Access Controller 49. The internal Access Controller 49 may contain an ID repository 55 which will identify users according to passwords and the like, a certificate server 60 to provide software certificate if such are required, and in some installations an audit logic 65 to log access of specific types by specific users. In order to perform those functions, internal Access Controller 49 has available to it databases for the authentication, rules, roles, and the like. The IPG 20 acts as an IP forwarding engine, and utilizes the internal Access Controller 49 to link the remote terminal or PC U1 with the Intranet and the appropriate resource connected thereto. The IPG may link between the external user U1 and different machines, using protocols and ports as dictated by the information received from the Access Controller. Oftentimes, the IPG creates a secure link such as by way of HTTPS or Virtual Private Network (VPN) to provide for secure access between the external user U1 and the Intranet. IPG may be a specialized computer such as a router or a firewall, a software only device such as a computer with an operating system that is constructed to provide forwarding. The internal Access Controller 49 is often incorporated within the IPG 20.

While this solution works, it has certain drawbacks. Major drawbacks are cost and knowledge level for required for operations. Managing access requires maintaining the Access Controller and associated databases, as well as the hardware. Time to manage the hardware and software is expensive, and updating the system can easily present errors that disrupt service. Additionally, VPN connections are notoriously troublesome and hard to maintain, a fact that often requires costly time from well skilled personnel.

The known solutions are also not conducive to inter-organization cooperation. Oftentimes cooperating organizations allow a certain level of access for users from cooperating organizations. Thus for example a goods distributor may allow certain clients access to the status of their orders, while preventing access to certain other portions of the organization. The user oftentimes have to authenticate himself to his own organization and only then gain access to the host organization, where he needs to authenticate himself to the host organization, a tedious process at best. If any detail changes in one organization, maintaining such access requires manual updating of the databases at the host organization, by the host information technology personnel. It will be appreciated that in these specifications, the term ‘organization’ is taken to mean a resource, or a group of resources, separated from the Internet by an IPG.

Cooperation between groups of computers is widely used, such as the organization wide systems provided by Windows NT Domains (trademark of Microsoft, Redmond Wash., USA). Such arrangements provide centralized access control to the domain, and specific access controls to computers and files. However, those arrangements lack the capacity to control access to the organization as a whole (i.e. control gateways) or control and manage multiple tunnels (i.e. port/address pairs).

Therefore there is a clear need for a solution that will simplify and reduce the costs of verifying identity and managing access rights in a single organization, and/or across organizations, as well as provide encryption and audit requirements if needed.

### BRIEF DESCRIPTION

These specifications make extensive use of the term applet, and while the term originally stems from the Java programming language, and while a Java applet is specifically directed to running within a web browser, the term as used in these specifications relates to the more common meaning, i.e. a small program that is downloadable to a computer, and is used to perform specific tasks connected with data communications. Therefore an applet may be written for example in a language like ActiveX or XML, and may or may not operate only within a web browser.

There is therefore provided, in accordance with the preferred embodiment of the present invention, a method for access management to a networked resource operable in conjunction with a requester coupled to the internet. The resource is coupled to the internet via a gateway having an external side and an internal side. The external side of the gateway is coupled to the internet and the internal side coupled to the networked resource, thus the gateway selectively controlling access between the internet and the internal side, and by extension to the networked resource. An access controller is coupled to the gateway, and a requester such as a PC or an automated computerized process, is coupled to the internet. The method comprising the steps of:
a) initiating session request from the requester to the gateway;
b) Transmitting the session request from the gateway to the access controller;
c) from the access controller, providing an authentication applet to the requester;
d) operating the authentication applet to transmit user login information to the controller;
e) authenticating the user information and ascertaining access rights based on the identity of the user; and
f) communicating the access rights from the access controller to the gateway;

An important aspect of the invention is that the access controller is coupled to the gateway via the external side, rather than being connected to the internal, protected side.

The preferred method further comprises the steps of:
g) from the access controller transmitting an access management applet to the requester;
h) from the access controller transmitting to the gateway a set of rules reflecting access rights for the authenticated user;
i) At the gateway establishing at least one secured access link with the access management applet when the access management applet is activated.

The access management applet is preferably customized to reflect access rights of the user, and more preferably is generated by the access controller as a web page for execution by the requester.

Preferably, the invention also comprises the step of maintaining audit information on actions taken by the requester. Such audit data may be received from the or from the access management applet.

In the most preferable embodiment, the access controller maintains a count of active sessions between requester and at least one networked resource. This allows the preferred embodiment to control access to a plurality of resources, in a plurality of organizations, all while utilizing a single authentication activity by the user. This access to multiple organizations is achieved by performing the following steps:
j) Utilizing the access management applet, requesting access to a second networked resource, separated from the internet by a second gateway;
k) In the second gateway requesting user authentication from the access controller;
l) At the access controller ascertaining access rights to the second networked resource, based on the identity of the user; and,
m) communicating the access rights from the access controller to the second gateway;
n) wherein the access rights are ascertained based on the user identity established with regard to the access of the first networked resource.

The optional use of a software certificate in conjunction with the access management applet, and wherein the step of requesting access to the second gateway comprises delivering the software certificate thereto provide additional security and ease of operation. Further optionally, the preferred embodiment further performs the step of providing information from the access controller to at least a first gateway, when a session is active between the requester and a second gateway, for preventing timeout of a session between the requester and the first gateway.

In another aspect of the invention, there is provided a method for access management to a networked resource, operating in conjunction with a gateway, the gateway having an external side and an internal side, the external side coupled to a public network and the internal side coupled to the networked resource, the gateway selectively controlling access between the external side and the internal side, the method comprises the steps of:
a) receiving a request for access to the networked resource from a requester coupled to the external side;
b) sending an authentication request to an access controller coupled to the external side of the gateway via communication link;
c) authenticating the requester using the access controller, said authentication comprising the steps of:
d) obtaining an authentication applet from the access controller;
e) uploading the authentication applet to the requester;
f) receiving login information from the requester; and,
g) confirm login information as authenticating requester;
h) obtaining information about access rights of the requester to the networked resource from the access controller; and
i) allowing or denying access to said resource according to the information.

The preferred embodiment of this aspect of the invention further comprises the steps of:
j) at the gateway, receiving an access management applet from the access controller;
k) uploading the access management applet to the requester;
l) establishing at least one secured access link with the access management applet when the access management applet is activated;
m) wherein the step of allowing access is performed utilizing the secured access link.

Optionally the access management applet comprises several code sections, each downloaded to requester when needed. Preferably, the communication between the requester and the gateway or the networked resource is facilitated by a software certificate generated by the access controller. Most preferably, the communication between the requester and the gateway or the networked resource is performed via a software tunnel.

In yet another aspect of the invention, there is provided a method for access management to a networked resource operating in conjunction with a requester coupled to the internet, a gateway having an external side and an internal side, the external side coupled to the internet and the internal side coupled to the networked resource, the gateway selectively controlling access between the internet and the internal side, and an access controller and a requester coupled to the internet, the method comprising the steps of, in the access controller:
a) receiving an authentication request from a gateway;
b) transmitting an authentication applet to the requester;
c) accepting user login information from the requester;
d) authenticating the user login information;
e) ascertaining access rights for networked resource by the user;
f) sending information regarding the user access rights to the networked resource;
g) sending an access management applet to the requester;
   wherein the access controller is coupled to the gateway via the external side.

Preferably this aspect of the invention further comprises, in the access controller, the steps of:
h) maintaining a count of active sessions associated with the user;
i) receiving an authentication request from a second server for the user, the authentication request comprising a software certificate or a portion thereof, the certificate associated with the user;

j) ascertaining access rights for a second networked resource by the user;
k) sending information regarding the user rights to the second gateway;
l) wherein the access rights are ascertained based on the user identity established with regard to the access of the first networked resource.

More preferably, this aspect of the invention further comprises the step of providing information from the access controller to at least a first gateway, when a session is active between the requester and a second gateway, for preventing timeout of a session between the requester and the first gateway.

The preferred embodiment of the gateway is further equipped for performing the step of receiving and logging audit information concerning activities preformed by the user.

In yet another aspect of the invention there is provide a method for access management to a networked resource, operating in conjunction with a gateway, the gateway having an external side and an internal side, the external side coupled to a public network and the internal side coupled to the networked resource, the gateway selectively controlling access between the external side and the internal side, the method comprises the steps of, at the gateway:
a) receiving a request for access to the networked resource from a requester coupled to the external side, the request comprises a software certificate or a portion thereof;
b) sending an authentication request to an access controller coupled to the external side of the gateway via a communications link, the authentication request comprises the software certificate or the portion thereof;
c) authenticating the requester using the access controller, utilizing the software certificate or the portion thereof;
d) obtaining information about access rights of the requester to the networked resource from the access controller; and
e) allowing or denying access to said resource according to the information.

### BRIEF DESCRIPTION OF THE DRAWINGS

Several aspects of the invention will be better understood in view of the accompanying drawings in which:

FIG. 1 depicts a simplified diagram of known and commonly used solution to authentication and access rights management.

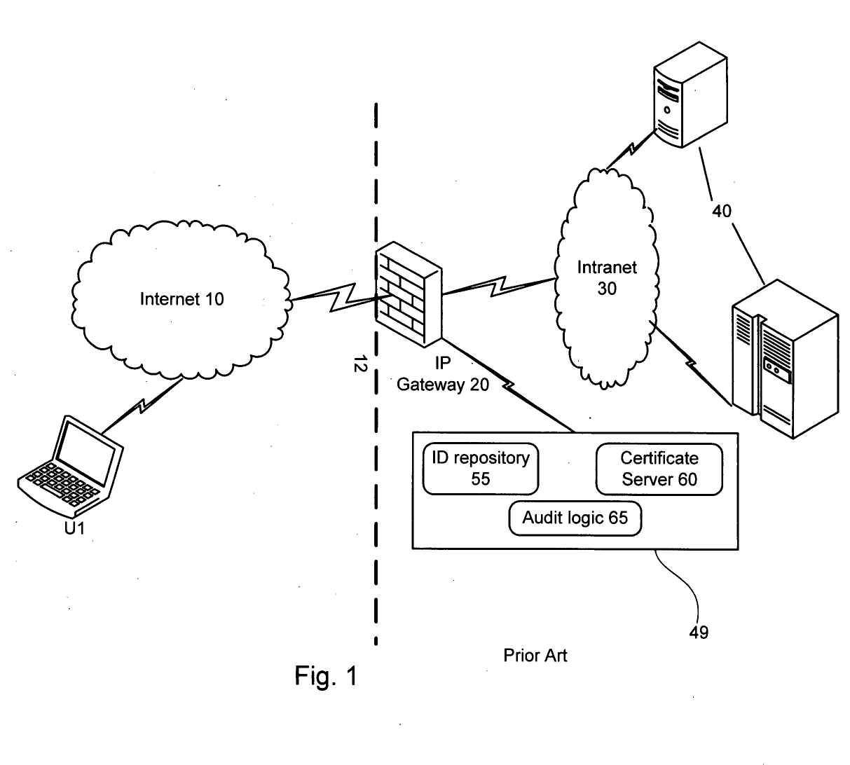

FIG. 2 depicts a simplified diagram showing a preferred embodiment of the invention

FIG. 3 is a simplified block diagram of the preferred login and initialization process.

FIG. 4 depicts an example of a screen which may be produced by the access management applet.

FIG. 5 depicts a simplified diagram showing a preferred embodiment containing a plurality of gateways and resources.

FIG. 6 depicts a flow diagram following a specific example of the operation of the preferred embodiment.

FIG. 7 depicts a simplified flow diagram showing an optional aspect of the invention facilitating using a single time login for a plurality of networked resources.

### DETAILED DESCRIPTION

While the present example relates to a user utilizing a personal computer (PC) the claims use the term ‘requester’ to denote inter alia the PC and the user. However a requester also relates to any entity requesting access to a networked resource, such as an automated process activated on a resource coupled to the public network which is in turn coupled to the public, or external side of the IPG.

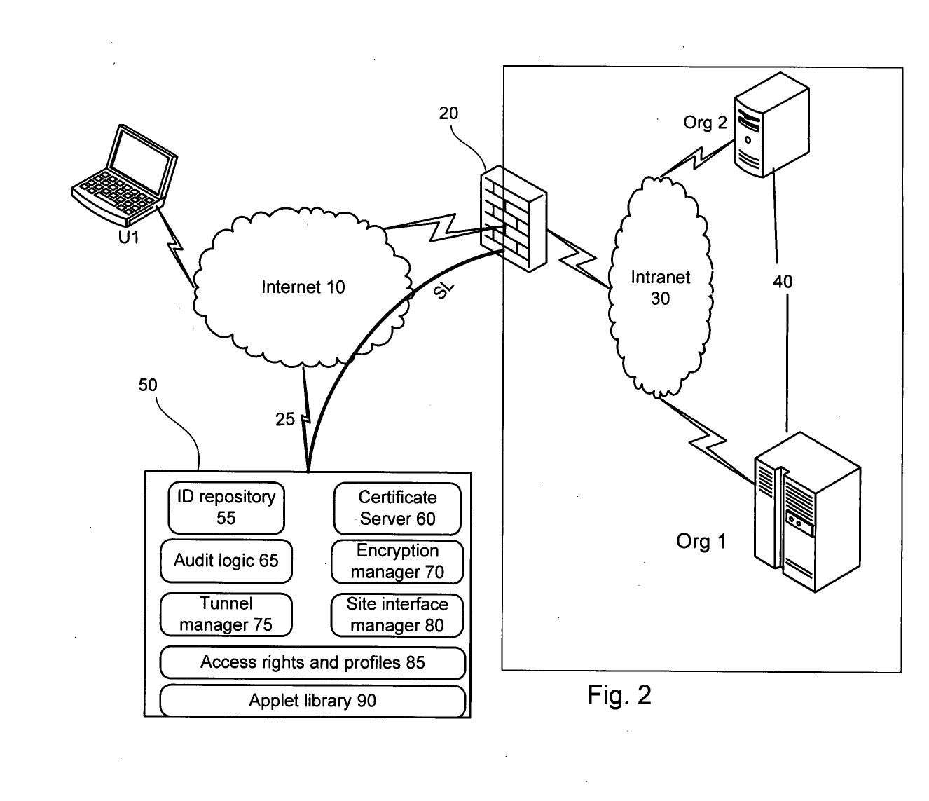

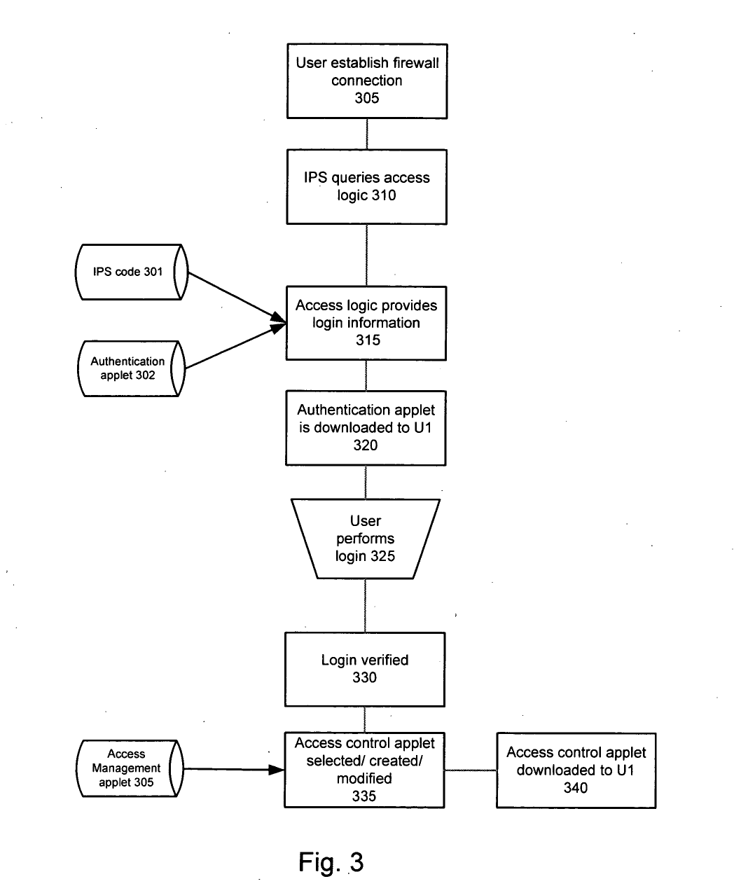

Some preferred embodiments will now be explained, utilizing the examples provided by the drawings. FIG. 2 depicts a simplified diagram of the preferred embodiment of the invention. FIG. 3 is a simplified flow diagram of the preferred embodiment, and will be used in conjunction with FIG. 2 to in the following example of system operation.

When user U1 attempts to access a computer within the organization Org1, an initial connection, also known as a ‘session request’ is established 305 with IPG 20. Such communication may be directed to a specific port at the IPG, which makes up a portion of the required URL (Universal Resource Locator). Thus a single IPG may serve a plurality of organizations. IPG 20 communicates 310 with an Access Controller 50 which is external to the intranet 30, preferably via an encrypted communications channel SL, that may or may not utilize the Internet 10 as a communication medium (thus the use of internet link 25 to the Access Controller is optional, but desirable for other communications, as will be seen later). The communication between the IPG 20 and Access Controller 50 is able to utilize an encrypted high security link such as SSL (Secured Socket Layer, utilizing well known port 443) for example, and preferably uses fixed IP addresses or even checks specific MAC (Media Access Code) on the perspective network interfaces.

Utilizing the URL as a guide, the Access Controller 50 provides the IPG 20 with information that defines a login screen specific to the site 315. A site interface manager module 80 in the Access Controller selects appropriate login screen. The login may be preformed as a web page presented and executed by the IPG, however the preferred embodiment calls for authentication logic, such as an authentication applet 302, to be downloaded to the user computer U1, more preferably via a secure link such as SSL via the IPG. The preferred embodiment also calls for executable logic 301 in the forms of rules, to be provided by the Access Controller 50 to the IPG, and the IPG already has software or other logic to handle the implementation of such rules. Alternatively, the executable logic 301 comprises complete code that is being transferred to the IPG. It will be noted that the logic 301 relates to the operation of the IPG whether it is implement a set of operational data like the rules described above, or as a complete downloaded software, or as any other combination that allows the IPG to communicate and cooperate with the applets downloaded to the user computer U1.

After the authentication applet 302 is downloaded and activated on the user computer, a communication link, preferably encrypted, is established between the user computer and the IPG 20. As the IPG and the user computer U1 have now established certain level of coordination between the authentication applet and the IPG logic, more complex authentication schemes, such as two part login or other ‘handshake’ arrangements are easily handled to provide enhanced security as desired.

After the user logs in, the user identity is authenticated using the ID repository in the Access Controller 50. The Access Controller then provides an access management applet to the user computer U1. It should be noted that while the access management applet 305 and the authentication applet 302 may be integrated, the preferred embodiment calls for the access management applet to be downloaded after authentication is completed. Doing so allows the site interface manager 80 to either selects or generates an applet best fitting the user, in conjunction with data provided by the access rights and profiles 85, and thus customize the user interface. Several applets may be prepared in advance, and one selected for each user, or the user interface manager may generate an applet by considering the user rights and preferences, and combine code pieces from the applet library 90 to create the access management applet specific to each user.

The IPG 20 has corresponding logic to the access management applet 305. The logic allows for establishing a secured access link, i.e. transparent communications between the user computer U1 and the target resource 30 and 40 behind the IPG 20. At least part of the secured access link is performed utilizing a protocol such as a handshake protocol, or preferably an encrypted connection, between the requester (in this case U1) and the networked resource. Most preferably the secured access link utilizes secured socket for communication between the requester and the IPG. The IPG logic may be downloaded as executable code 301 at any desired time, such as at the first login attempt, after login is established, or during a user session as needed. The logic (and the applet) may also be downloaded in parts, as required, or even updated responsive to actions taken by the user. Alternatively the IPG may have the logic or a part thereof already installed therein, and is driven by data received from the Access Controller 50. The combination of IPG logic and applets provide a number of services, as desired and/or dictated by the applet controller.

Perhaps the most desirable of the services is the provision of a secure link. If encryption is desired, it may also be established utilizing the encryption manager 70. Certificate server 60 in the Access Controller 50 may be further utilized to provide software certificates for access to one or more organization or application. The preferred embodiment calls for the establishment of a VPN (Virtual Private Network) after the user is authenticated 330, and prior to downloading the access management applet 305 to the user computer. The certificate manager 60 provides the required encryption certificate.

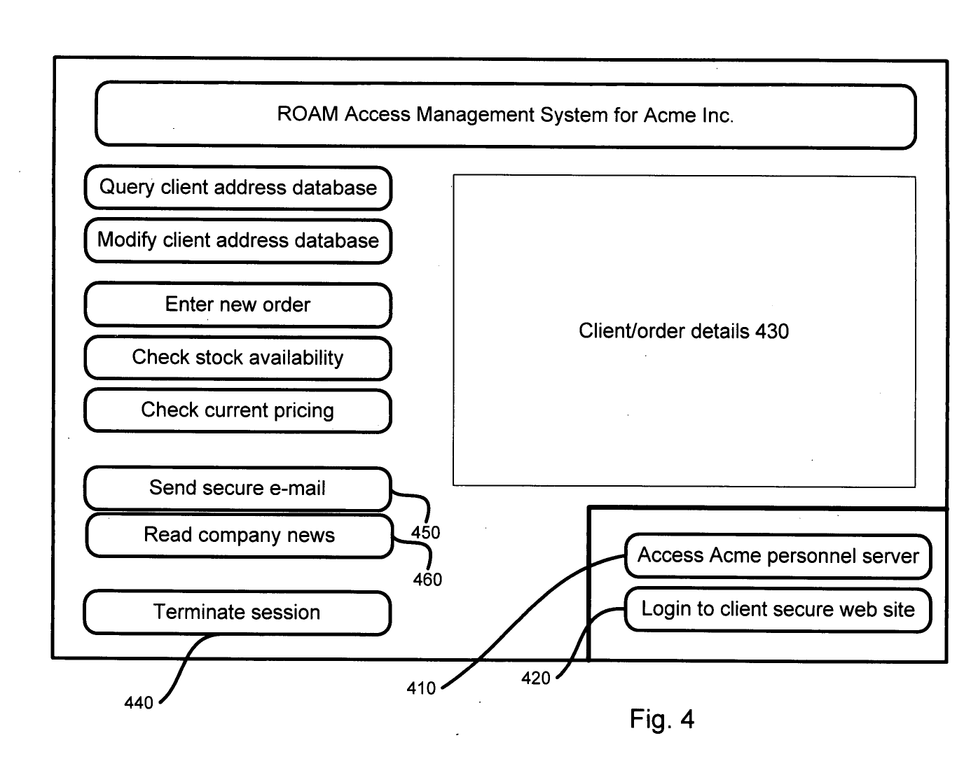

The interaction between the IPG 20 and the access management applet 305 sets rules of engagement that define access rights, preferences, and the like. Thus by way of the example shown in FIG. 4, the applet 305 may display a list of possible activities such as e-mail, 450 database browsing, certain file 460 or record access, and the like, that the user may perform. The access management applet 305 and the IPG logic 301 than establish a communication channel to handle the request, and the IPG directs the request to the desired resource, and handles all communications matters. The communication channel may be any common channel, such as for example, an unreliable link as UDP, a reliable link as TCP, SSL, an IP addres:port combination or a tunnel, i.e. a secure link using specific source and destination ports, encryption, and if desired compression. Therefore, if the user selects to access sensitive data the applet 305 and the IPG 20 handle all the data security as needed, even if a plurality of channels is required. Conversely, simple communication that does present high data security requirements, may be sent to other ports on the IPG does obviating the need for decryption and thus reducing load on the IPG or the source and destination resources.

In the most preferred embodiment, every button on the access management screen causes another ‘mini applet’ to be launched, so the access management applet acts like a portal. The mini applet process all access parameters as needed, such as encryption, login, auditing, and the like, required during a communication session to the specific resource, thus presenting the user with a tailored user interface for the requested task or resource. Mini applets may be downloaded as a part of the access management applet download, or they may be downloaded dynamically according to need.

The creation of a tunnel as described above allows utilizing the combination of the access management applet 305 in conjunction with IPG logic 301 offers a plurality of services in a controlled and secured environment. Practically all rules of engagement between the user computer U1 and the destination resource which may be any resource on the Intranet 30 such as servers 40, printers, and the like, are controlled by the applet/IPG interaction. As the tunnel is controlled by the applet, the applet practically controls what the user may or may not do. The corresponding logic 301 on the IPG 20 will serve as an agent directing the traffic to its destination, while handling all security issues, provide certificate or other security to prevent an abuse, such as by switching applets, and the like.

Optionally, the applet communicates with the audit logic 65 in the Access Controller 50 utilizing internet access link 25. Audit logic 65 is thus able to provide complete tracking of the action, taken by the user as relating to the target resource. The exchange of information between the applet and the Access Controller is preferably done using a secured link. The audit logic may keep track in a database of any attempted access and if such attempt was successful or not, and of any changes made, as customary in computer system audits. The skilled in the art will recognize that equivalent operation may be provided by having the IPG send information to the audit logic 65. Therefore the invention, and the claimed features, further extends to this equivalent feature of having audit information provided by the applet, the IPG, or a combination thereof. Thus, when the audit option is used, the preferred embodiment further reduces the risk of log tampering because the audit facility is established outside the organization.

Additional benefit which may be provided by the access logic is the ability to provide authentication and access control to a plurality of organizations. By way of non-limiting example the applet may include buttons allowing the user access to other organizations 420, or to resources that are limited by the users' role in the organization 410. When the user attempts to establish communication with a second organization Org2, the access management applet 305 sends a request to the access logic 50 to access the second organization. After verifying that the user has access rights to the second organization, the certificate manager 60 generates a certificate and sends a portion of it to the user computer U1. Using this certificate, the user attempts to connect to specific port on the IPG 21 of the second organization ORG2. The second IPG communicate the access request to the Access Controller 50, and the Access Controller provides the second IPG 21 with a complementary portion of the certificate, and thus authentication has been established. The Access Controller may also create a second version of the access management applet that will fit the user access rights in the second organization. Such applet may replace the applet already on the user computer, and provide access management for the first and second organization, or may be downloaded and operated as a separate applet. However, preferably each ‘mini applet’ is a separate thread, i.e. an instance of the access management applet 305. Thus each ‘mini applet’ or thread may have its own set of rules such as its own tunnel, with associated encryption protocol, target resource, response set, and the like. If the ‘mini applets’ or threads are used, in a system where auditing is implemented, the preferred embodiment will have each of the threads establishing an individual tunnel, with independent encryption. The IPG will report the creation of each tunnel, and the tearing down of such tunnel, and thus allow auditing of parameters like time parameters to audit logion/logout times, and time spent accessing a resource. In certain cases, the portal actions and links has a corresponding applet at the target resource, to provide more specific response for an application or an activity.

While access to a single organization may be terminated by the IPG of that site, maintaining access to a plurality of organization is best accomplished by a tunnel manager module 75 in the Access Controller 50. When a tunnel is established with an IPG, or when a tunnel is closed, the respective IPG registers the tunnel creation or closure with the tunnel manager 75. The tunnel manager maintains a count of open tunnels for the user. When all tunnels are closed, the certificate is revoked and the user will have to be authenticated again when s/he attempts to access the resources again. Timeout protection schemes are well known in the art and may be managed by each individual IPG, or by the Access Controller, resetting the timeout every time the user access one of the controlled resources. The preferred embodiment calls also for a timeout scheme whereby if the user does not perform any communication activity for a certain amount of time, the session is considered inactive, and terminates.

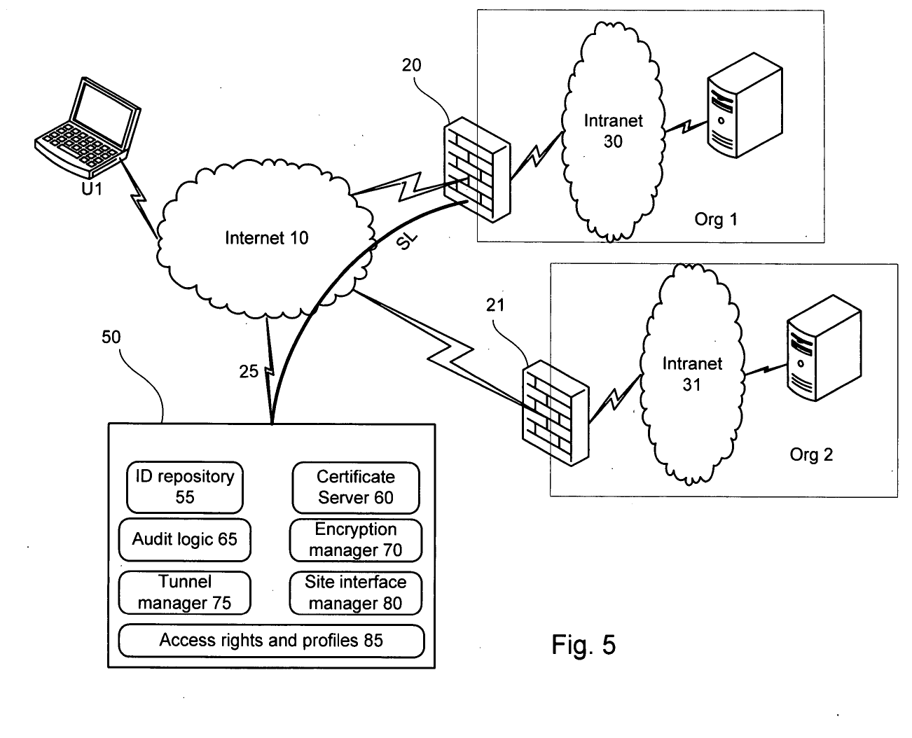

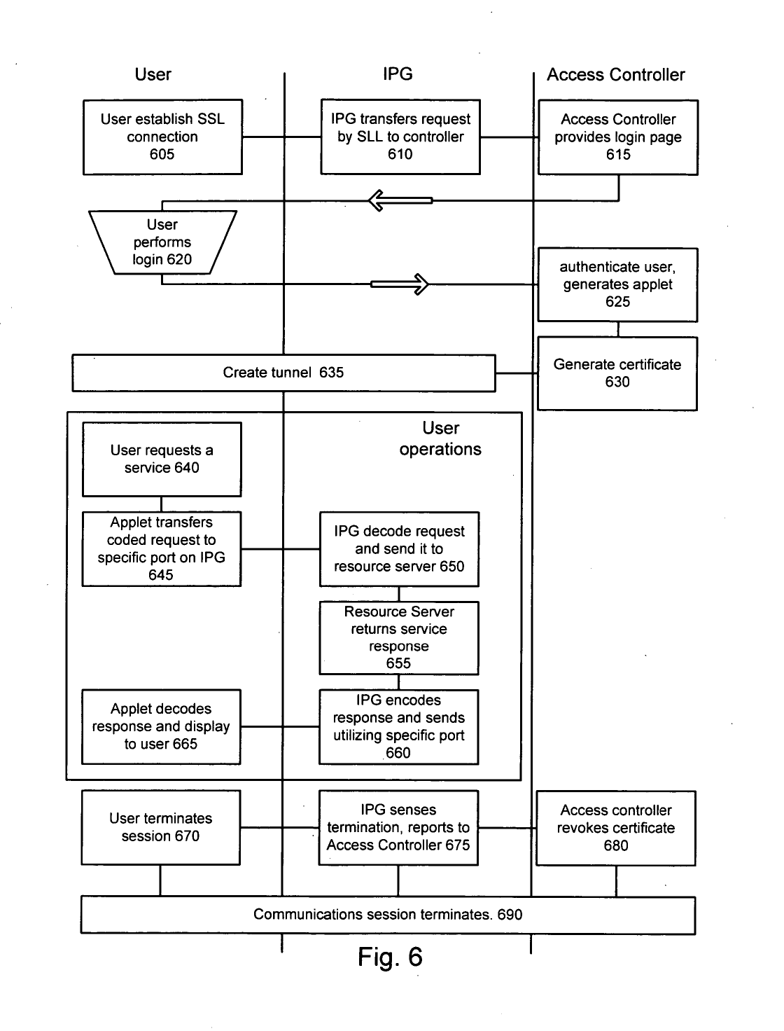

In order to facilitate understanding of the preferred embodiment of the invention, a detailed, but non limiting example of a sequence of operations and events associated with a user session is provided. The reader is referred to FIGS. 5 and 6 for further clarification.

The operation begins when the user, utilizing a common HTTP and Java enabled browser, requests an SSL connection 605 to the IPG separating the desired resource from the internet. The IPG 20 passes the request to the Access Controller 50 via SSL 610. Access Controller 50 utilizes the requested URL, and returns an authentication applet 615 in the form of a web page to the IPG, which forwards it via SSL to the user computer U1 as indicated by the arrow. The user performs a login utilizing the web page 620. The login attempt may comprise a simple login/password pair, multiple authentication schemes, biometric data, and the like. The request is communicated to the Access Logic via the IPG. The Access Controller 50 authenticates the user, and utilizes the user profile and access rights repository 85 to associate the user with a profile. Using the profile, the Access Controller either selects an applet from the applet library 90, or more preferably selects certain code routines from the applet library, and generates 625 the access management applet. The certificate server 60 generates a software certificate for secure communications. According to the user access rights, the access controller further generates certain rules for the IPG. The rules for the IPG direct the IPG how to respond to specific requests. Thus for example a rule may dictate that a request for a specific port/IP address will be transferred to a specific resource coupled to the Intranet 30, encryption rules for communicating to the user computer according to each port, and the like.

The certificate and the access management applet, as well as the rules are delivered to the IPG 20. The IPG then transfers the access management applet and a portion of the certificate to the user computer, and the applet and the IPG create the required number of tunnels as known. Optionally the IPG may log the user into one or more resources.

The user then is free to use the resources provided by the access control management, such as querying the client database, modifying certain portions of the database, and enter new orders. The client and/or order information are displayed in the client/order details area 430. By way of example, other functions like the secure e-mail 450 are also handled by the access management applet. The applet may also provide unsecured links such as the link to company news 460. A plurality of service requests may occur and the process is repeated as many times as needed, in which the operations contained within the box marked “User Operations” are repeated as required. If the user elects to terminate the session 670 a message to that effect is sent to the IPG. The IPG 20 receives the messages, closes the tunnels and performs other tasks associated with session termination, and notifies the Access Controller, which indicates that the user is not logged on any longer, revokes the certificate 680 and the communication session ends.

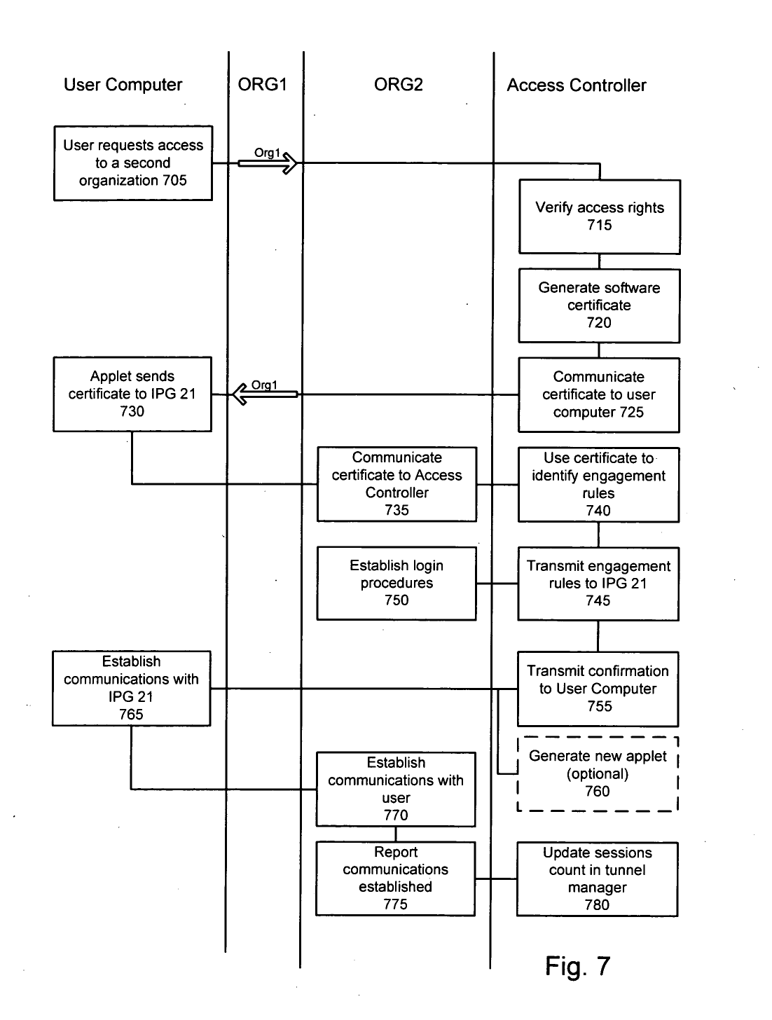

The user may wish to access a resource requiring additional authentication. Such resource may comprise a part of the current organization, for example accessing the company personnel database, or the resource may belong to a second organization, such as accessing a client secure web site, and the like. A simplified process is described in FIG. 7, with reference to FIG. 5. The user may thus press he buttons 410 or 420, and thus initiate a request for such access 705. The access management applet 305 communicates the request to Access Controller 50. The applet may communicate directly to with the Access Controller 50 via internet link 25, using an earlier provided certificate, or it may communicate with the IPG 20 of organization ORG1, which in turn communicates the request to the Access Logic. In the case of a request to an intra-organization resource, the Access Logic may simply provide additional authorization, or require additional actions by the user, utilizing the applet 305, a new version of applet 305, or a different applet, and/or modify the rules provided to IPG 20. If however the user requests access to a resource residing in a second organization ORG2, the Access Controller verifies 715 that the user has access rights to that organization and resource. If the user does indeed have access rights, the Access Controller generates a software certificate that will assist the user computer to establish communication with the IPG of the second organization. The applet at the user computer then creates a connection 730 with the IPG 21 at ORG2 using a well known SSL port, and communicates to IPG 21 a certificate key. IPG 21 communicates 735 the certificate portion to the Access controller, which uses it to identify locate 740 rights and other engagement rules specific to the user at the ORG2 environment. The rules are communicated 745 to the IPG 21 in a similar manner to the manner described for IPG 20. Therefore IPG 21 is able to establish communications and other login capacities 750 for the user. It will be noted that the rules may differ significantly between organizations.

The Access Controller 50 also transmits a confirmation 755 to the user computer U1. This transmission may occur by any convenient means such as directly over the internet (preferably via secure link), via ORG1 IPG 20, or via the newly established connection of IPG 21. Optionally a new or updated applet is also selected or generated 760 and sent to the user computer U1. The user computer establishes communication 765 with IPG 21 in a similar manner described for IPG 20 and therefore to the resources of ORG2 connected to intranet 31.

If such a transparent login procedures between different organizations is established, it is desirable to know when all sessions have been terminated. It is therefore desirable to log each and every case of establishment of communications. Thus after establishments of communications 770 like tunnels and the like, IPG 21 reports 775 the establishment of a communication session to Access Controller 50, which utilizes this information to track open session using tunnel manager module 75. When the last open session to any organization is closed, the tunnel manager revokes all pending certificates, and the user will need to login again for the next session. The tunnel manager may further assist in preventing undesirable timeout, whereby if a session is active to one resource in one organization, time dependent resources in other organizations periodically receive minimum null activity to maintain the tunnel open.

The skilled in the art will recognize that additional functions may be implemented. Thus, by way of example, the certificate server may be used to generate certificates for encryption of each specific service, the audit logic may log unsuccessful login attempts, and other common uses of the system components.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

We claim:

1. A method for access management to a networked resource operable in conjunction with a requester coupled to the internet, a gateway having an external side and an internal side, the external side coupled to the internet and the internal side coupled to the networked resource, the gateway selectively controlling access between the internet and the internal side, an access controller coupled to the gateway, and a requester coupled to the internet, the method comprising the steps of:
initiating session request from the requester to the gateway;
Transmitting the session request from the gateway to the access controller;
from the access controller, providing an authentication applet to the requester;
operating the authentication applet to transmit user login information to the controller;
authenticating the user information and ascertaining access rights based on the identity of the user; and
communicating the access rights, or lack thereof, from the access controller to the gateway;
wherein the access controller is coupled to the gateway via the external side.

2. A method for access management as claimed in claim 1, wherein the authentication applet is selected according to the requested networked resource.

3. A method for access management as claimed in claim 1, wherein in said step of providing the authentication applet is carried out via the gateway.

4. A method for access management as claimed in claim 1, further comprising the steps of:
from the access controller transmitting an access management applet to the requester;
from the access controller transmitting to the gateway a set of rules reflecting access rights for the authenticated user;
At the gateway establishing at least one secured access link with the access management applet when the access management applet is activated.

5. A method for access management as claimed in claim 4, wherein the step of transmitting the access management applet comprises the steps of transmitting the access management applet from the access controller to the gateway, and then transmitting the access management applet from the gateway to the requester.

6. A method for access management as claimed in claim 4, wherein the access management applet is customized to reflect access rights of the user.

7. A method for access management as claimed in claim 4, wherein the access management applet is integrated with the authentication applet.

8. A method for access management as claimed in claim 4, wherein the access management applet comprises a plurality of code segments and wherein the code segments are downloaded to the requester on demand.

9. A method for access management as claimed in claim 1, further comprising the step of maintaining audit information on actions taken by the requester.

10. A method for access management as claimed in claim 9, wherein audit data is received from the gateway.

11. A method for access management as claimed in claim 9 wherein audit data is received from the access management applet.

12. A method for access management as claimed in claim 1, wherein sending the login information to the access controller is performed via the gateway.

13. A method for access management as claimed in claim 1, wherein the access controller maintains a count of active sessions between requester and at least one networked resource.

14. A method for access management as claimed in claim 1, further comprising the steps of:
Utilizing the access management applet, requesting access to a second networked resource, separated from the internet by a second gateway;
In the second gateway requesting user authentication from the access controller;
At the access controller ascertaining access rights to the second networked resource, based on the identity of the user; and,
communicating the access rights from the access controller to the second gateway;
wherein the access rights are ascertained based on the user identity established with regard to the access of the first networked resource.

15. A method for access management as claimed in claim 14, wherein the access management applet contains a software certificate or a portion thereof, and wherein the step of requesting access to the second gateway comprises delivering the software certificate thereto.

16. A method for access management as claimed in claim 14, further comprising the step of providing information from the access controller to at least a first gateway, when a session is active between the requester and a second gateway, for preventing timeout of a session between the requester and the first gateway.

17. A method for access management to a networked resource, operating in conjunction with a gateway, the gateway having an external side and an internal side, the external side coupled to a public network and the internal side coupled to the networked resource, the gateway selectively controlling access between the external side and the internal side, the method comprises the steps of, at the gateway:
receiving a request for access to the networked resource from a requester coupled to the external side;
sending an authentication request to an access controller coupled to the external side of the gateway via communication link;
authenticating the requester using the access controller, said authentication comprising the steps of:
obtaining an authentication applet from the access controller;
uploading the authentication applet to the requester;
receiving login information from the requester; and,
confirm login information as authenticating requester;
obtaining information about access rights of the requester to the networked resource from the access controller; and
allowing or denying access to said resource according to the information.

18. A method for access management to a networked resource as claimed in claim 17, wherein the secured communication link utilizes the Internet.

19. A method for access management to a networked resource as claimed in claim 18, wherein the secured link is established utilizing a secured communication protocol.

20. A method for access management to a networked resource as claimed in claim 17, wherein the step of uploading is preformed via a secured communication protocol.

21. A method for access management to a networked resource as claimed in claim 17, further comprising the steps of:
at the gateway, receiving an access management applet from the access controller;
uploading the access management applet to the requester;
establishing at least one secured access link with the access management applet when the access management applet is activated;
wherein the step of allowing access is performed utilizing the secured access link.

22. A method for access management to a networked resource as claimed in claim 21, wherein the access management applet acts as a user interface for providing controlled access to the networked resource.

23. A method for access management to a networked resource as claimed in claim 21, wherein the access management applet is customized.

24. A method for access management to a networked resource as claimed in claim 21, wherein the access management applet and the authentication applet are integrated.

25. A method for access management to a networked resource as claimed in claim 17, wherein the access management applet comprises several code sections, each downloaded to requester when needed.

26. A method for access management to a networked resource as claimed in claim 17, wherein the communication between the requester and the gateway is facilitated by a software certificate generated by the access controller.

27. A method for access management to a networked resource as claimed in claim 17, wherein the communication between the requester and the networked resource is facilitated by a software certificate generated by the access controller.

28. A method for access management to a networked resource as claimed in claim 17, wherein the information about access rights is provided to the gateway as a set of rules.

29. A method for access management to a networked resource as claimed in claim 28, wherein the set of rules includes information for communicating with portions of an access management applet associated with specific networked resources.

30. A method for access management to a networked resource as claimed in claim 17, wherein access to the networked resource done via a software tunnel.

31. A method for access management to a networked resource operating in conjunction with a requester coupled to the internet, a gateway having an external side and an internal side, the external side coupled to the internet and the internal side coupled to the networked resource, the gateway selectively controlling access between the internet and the internal side, and an access controller coupled to the external side, and a requester coupled to the internet, the method comprising the steps of, at the access controller:
receiving an authentication request from a gateway;
transmitting an authentication applet to the requester;
accepting user login information from the requester;
authenticating the user login information;
ascertaining access rights for networked resource by the user;
sending information regarding the user access rights, or lack thereof, to the networked resource;
sending an access management applet to the requester;
wherein the access controller is coupled to the gateway via the external side.

32. A method for access management to a networked resource as claimed in claim 31, wherein the step of transmitting the authentication applet occurs via the gateway.

33. A method for access management to a networked resource as claimed in claim 31, wherein the authentication applet is selected according to the requested networked resource.

34. A method for access management to a networked resource as claimed in claim 31, wherein the step of sending an access management applet is performed via the gateway.

35. A method for access management to a networked resource as claimed in claim 31, wherein the access management applet is customized.

36. A method for access management to a networked resource as claimed in claim 31, wherein the access applet comprises a software certificate.

37. A method for access management to a networked resource as claimed in claim 31, wherein the access management applet comprises an encryption key.

38. A method for access management to a networked resource as claimed in claim 31, wherein the access management applet is being synthesized by the access controller for a specific user and access rights associated with that user.

39. A method for access management to a networked resource as claimed in claim 31, further comprising the steps of:
in the access controller maintaining a count of active sessions associated with the user;
receiving an authentication request from a second server for the user, the authentication request comprising a software certificate or a portion thereof, the certificate associated with the user;
ascertaining access rights for a second networked resource by the user;
sending information regarding the user rights to the second gateway;
wherein the access rights are ascertained based on the user identity established with regard to the access of the first networked resource.

40. A method for access management to a networked resource as claimed in claim 39, further comprising the step of providing information from the access controller to at least a first gateway, when a session is active between the requester and a second gateway, for preventing timeout of a session between the requester and the first gateway.

41. A method for access management to a networked resource as claimed in claim 31, further comprising the steps of receiving and logging audit information concerning activities preformed by the user.

42. A method for access management to a networked resource as claimed in claim 31, wherein the audit information is received from the access management applet.

43. A method for access management to a networked resource as claimed in claim 31, where the audit information is received from the gateway.

44. A method for access management to a networked resource as claimed in claim 31, wherein the information regarding the user access rights comprise a set of access rules.

45. A method for access management to a networked resource, operating in conjunction with a gateway, the gateway having an external side and an internal side, the external side coupled to a public network and the internal side coupled to the networked resource, the gateway selectively controlling access between the external side and the internal side, the method comprises the steps of:
receiving a request for access to the networked resource from a requester coupled to the external side, the request comprises a software certificate or a portion thereof;
sending an authentication request to an access controller coupled to the external side of the gateway via a communications link, the authentication request comprises the software certificate or the portion thereof;
authenticating the requester using the access controller, utilizing the software certificate or the portion thereof;
obtaining information about access rights of the requester to the networked resource from the access controller; and
allowing or denying access to said resource according to the information.
